(19) United States
(12) Patent Application Publication
(10) Pub. No.: US 2024/0153669 A1
(43) Pub. Date: May 9, 2024

(54) WIRE CONDUCTOR AND INSULATED WIRE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yusuke MAEJIMA, Mie (JP); Yasuyuki OTSUKA, Mie (JP); Fumitoshi IMASATO, Mie (JP)

(21) Appl. No.: 18/284,216

(22) PCT Filed: Mar. 28, 2022
(86) PCT No.: PCT/JP2022/014776

§ 371 Date: Sep. 26, 2023

(30) Foreign Application Priority Data
Mar. 31, 2021 (JP) 2021-061051

(51) Int. Cl. H01B 7/00; H01B 7/08

(52) U.S. Cl. CPC H01B 7/0009; H01B 7/08

(57) ABSTRACT

A wire conductor 10 includes a single core wire 11 made of stainless steel and a copper coating layer 12 made of copper or a copper alloy and covering an outer circumferential surface of the core wire. The wire conductor 10 has a cross-sectional area of less than 0.13 mm² and a Young's modulus of less than 1.1×10⁵ MPa, and is to be used as a single wire. Also, an insulated wire 1 includes the wire conductor 10 and an insulating sheath 20 covering the outer circumferential surface of one of the wire conductors.

### TECHNICAL FIELD

The present disclosure relates to a wire conductor and an insulated wire.

### BACKGROUND

Communication cables are connected to various communication devices via connectors in automobiles, and the size and the weight of connectors have been reduced along with a size reduction of devices. When the size of a connector is reduced, the diameter of the communication cable connected to the connector needs to be reduced as well. In Patent Document 1, a twisted wire conductor whose cross-sectional area is reduced to 0.13 mm² is used as a twisted wire conductor obtained by using bare wires made of a Cu-alloy containing Fe, for example.

### PRIOR ART DOCUMENT

### Patent Document

Patent Document 1: JP 2018-085344 A
Patent Document 2: JP 2018-037324 A

### SUMMARY OF THE INVENTION

### Problems to be Solved

If, as with the conductor used in Patent Document 1 above, a conductor has a cross-sectional area of about 0.13 mm², even when the diameter of conventional copper alloy twisted wires is reduced, the strength of the wires and the strength of connection when the connector is connected can be sufficiently ensured. However, in recent years, there is also demand for communication cables provided with conductors whose cross-sectional area is even smaller than 0.13 mm², along with a size reduction of connectors. It is difficult to reduce the diameter of a twisted wire conductor to a region where the cross-sectional area of the conductor is smaller than 0.13 mm², although it is conceivable to form such a conductor using a single wire. However, if a conventional copper alloy wire is directly used as a single wire, it will be difficult to ensure sufficient wire strength. If wire strength decreases, the wire conductor tends to buckle. When a wire conductor is inserted into a connector terminal for connection, if the wire conductor comes into contact with a wall surface of the connector terminal, for example, the wire conductor may buckle. If the wire conductor buckles, then it will be difficult to successfully complete insertion of the wire conductor into the connector terminal.

In view of this, the present disclosure aims to provide a wire conductor capable of reducing the influence of buckling when the wire conductor is inserted into a connector terminal even when the cross-sectional area of the conductor is smaller than 0.13 mm², and an insulated wire provided with such a wire conductor.

### Means to Solve the Problem

A wire conductor according to this disclosure includes a single core wire made of stainless steel and a copper coating layer made of copper or a copper alloy and covering an outer circumferential surface of the core wire. The wire conductor has a cross-sectional area of less than 0.13 mm² and has a Young's modulus of less than 1.1×10⁵ MPa, and is to be used as a single wire.

An insulated wire according to this disclosure includes the wire conductor and an insulating sheath covering an outer circumferential surface of one of the wire conductors.

### Effect of the Invention

The wire conductor and the communication cable according to this disclosure are a wire conductor capable of reducing the influence of buckling when being inserted into a connector terminal even when making the cross-sectional area of the conductor smaller than 0.13 mm², and an insulated wire provided with such a wire conductor.

### BRIEF DESCRIPTION OF THE DRAWINGS

FIG. 1 is a cross-sectional view of an insulated single wire according to an embodiment of this disclosure.

FIGS. 2A and 2B are cross-sectional views of flat wires. FIGS. 2A and 2B show flat wires having different forms.

FIGS. 3A and 3B are side views illustrating buckling of a wire, FIG. 3A showing a state before the wire buckles, and FIG. 3B showing a state after the wire buckles.

FIG. 4 is a diagram showing results obtained by measuring a buckling force for insulated wires having three types of wire conductors.

FIGS. 5A to 5C are photographs obtained by capturing images of buckled insulated wires having three types of wire conductors. FIG. 5A shows a softened copper-clad SUS wire, FIG. 5B shows an unsoftened copper-clad SUS wire, and FIG. 5C shows a Cu—Sn alloy wire. The test distance is 2.0 mm in FIGS. 5A to 5C.

FIG. 6 is a diagram showing results obtained by measuring the amount of buckling (buckling amount) of insulated wires having three types of wire conductors.

FIG. 7 is a diagram showing results of evaluation of the relationship between the tensile strength and the buckling amount of a wire conductor.

FIGS. 8A and 8B are diagrams showing results of evaluation of the relationship between the tensile strength and the crimp strength of a wire conductor. FIG. 8A shows the relationship under low compression, and FIG. 8B shows the relationship under high compression.

### DETAILED DESCRIPTION TO EXECUTE THE INVENTION

### Description of Embodiments of the Present Disclosure

First, embodiments of this disclosure will be described below.

A wire conductor according to this disclosure includes a single core wire made of stainless steel and a copper coating layer made of copper or a copper alloy and covering an outer circumferential surface of the core wire. The wire conductor has a cross-sectional area of less than 0.13 mm² and has a Young's modulus of less than 1.1×10⁵ MPa, and is to be used as a single wire.

Because the wire conductor has a structure in which a copper coating layer is provided on the outer circumferential surface of the core wire made of stainless steel, the wire conductor has high material strength and is unlikely to buckle when the wire conductor is inserted into a connector terminal, for example, even though the cross-sectional area of the wire conductor is as small as less than 0.13 mm². That is, because the copper coating layer made of a material with low rigidity is disposed on the outer circumferential surface of the core wire made of stainless steel with high rigidity, even when the wire conductor is deformed when the wire conductor is inserted into the connector terminal, the deformed wire conductor is likely to return to an unbuckled state and is not irreversibly buckled. Because the copper coating layer with low rigidity is present, the overall Young's modulus of the wire conductor has a small value of less than 1.1×10⁵ MPa, and its buckling force is smaller than that of a material with a higher Young's modulus. Therefore, the wire conductor is likely to buckle under a small force when the wire conductor is inserted into the connector terminal. However, the copper coating layer contributes to making the buckled wire conductor effectively return to the unbuckled state, thus reducing the amount of deformation of the wire conductor under buckling. As a result, buckling when the wire conductor is inserted into the connector terminal has a weaker influence.

The Young's modulus of the core wire is preferably at least 1.2×10⁵ MPa. As a result, when the core wire has a high Young's modulus, the wire conductor is more effective in reducing the buckling force and the overall amount of deformation of the wire conductor under buckling, and thus is more effective in reducing the influence of buckling.

The tensile strength of the wire conductor is preferably at least 950 MPa. As a result, the strength of the wire conductor is increased, and the wire conductor is unlikely to buckle when the wire conductor is inserted into the connector terminal. Further, when the connector terminal is inserted into the wire conductor and crimped, the crimped portion has high strength. A wire conductor having such tensile strength can be favorably manufactured through heat treatment.

Stainless steel forming the core wire is preferably SUS 304H. SUS 304H has a high Young's modulus and high tensile strength, and exhibits breaking elongation, and thus can be favorably used as a constituent material of the core wire.

An insulated wire according to this disclosure includes the wire conductor and an insulating sheath covering an outer circumferential surface of one of the wire conductors. This insulated wire has a small conductor cross-sectional area of less than 0.13 mm², and its diameter can be readily reduced. However, when the insulated wire having the above predetermined structure and physical properties is used, the insulated wire is unlikely to be affected by buckling when the wire conductor is inserted into the connector terminal. Therefore, this insulated wire can be favorably used as a communication cable connected to a small connector in an automobile or the like.

A plurality of the wire conductors may be arranged parallel to each other, and the wire conductors are respectively covered by the insulating sheaths to form covering portions, and the covering portions are preferably connected to each other by one or more connection portions that are formed as single bodies with the insulating sheaths of the covering portions. When the plurality of wire conductors are arranged parallel to each other, the strength of the entire insulated wire is improved. Also, when the plurality of wire conductors are arranged parallel to each other and the distance between wire conductors is stably maintained by connection portions, the resulting cable can be used as a communication cable with stable communication characteristics. Because the wire conductors are unlikely to be affected by buckling when the wire conductors are inserted into the connector terminals, the wire conductors can be collectively inserted into a plurality of terminals of a connector.

In this case, the distance between at least two adjacent wire conductors preferably ranges from 0.2 mm to 1.2 mm. As a result, these two wire conductors can be favorably used as a pair of wires for transmitting differential signals while maintaining sufficient insulation between conductors.

### DETAILS OF EMBODIMENTS OF THE PRESENT DISCLOSURE

Hereinafter, embodiments of this disclosure will be described in detail with reference to the drawings. Terms indicating the shape and arrangement of members, such as “parallel” and “perpendicular”, include not only geometrically strict concepts but also errors in a range that is generally allowable for communication cables in this specification. Further, the values of various physical properties are obtained through measurement in an atmosphere at room temperature (about 15° C. to 25° C.) in this specification.

<Overview of Wire Conductor and Communication Cable>

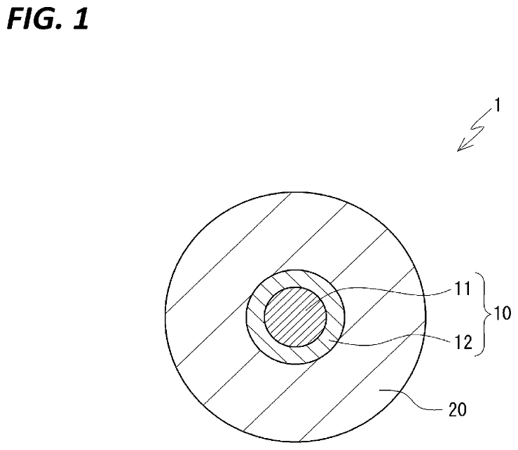

FIG. 1 is a cross-sectional view of an insulated wire 1 according to an embodiment of this disclosure including a wire conductor 10 according to an embodiment of this disclosure.

The wire conductors 10 according to this embodiment of the disclosure are used as a single wire. Specifically, the wire conductors 10 are used in a state in which each wire conductor 10 is insulated, and are not used in a state in which a plurality of uninsulated wire conductors 10 are twisted or bundled together. In the insulated wire 1 shown in FIG. 1, an insulating sheath 20 is formed by covering an outer circumferential surface of one wire conductor 10.

The wire conductor 10 includes a single core wire 11, and a copper coating layer 12 covering the outer circumferential surface of the core wire 11. The core wire 11 and the copper coating layer 12 are joined into a single body. The core wire 11 is made of stainless steel (SUS). There is no particular limitation on the type of SUS, and austenitic SUS, in particular, SUS 304H and SUS 304L can be favorably used. The copper coating layer 12 is made of copper or a copper alloy. Preferably, from the viewpoint of keeping the rigidity of the copper coating layer 12 low, the copper coating layer 12 is made of pure copper that does not contain any additive element other than inevitable impurities. Although another type of layer may be arranged between the core wire 11 and the copper coating layer 12 in order to increase bondability between the core wire 11 and the copper coating layer 12, for example, it is preferable that the copper coating layer 12 is formed in direct contact with the surface of the core wire 11.

Here, component compositions of SUS 304H and SUS 304L are listed in Table 1 below. SUS 304H and SUS 304L differ from each other in the C content and the Ni content.

TABLE 1

| | Content (mass %) | | | | | | | |
|---|---|---|---|---|---|---|---|---|
| | C | Si | Mn | P | S | Cr | Ni | Fe |
| SUS | ≤0.08 | ≤1.00 | ≤2.00 | ≤0.045 | ≤0.030 | 18.0-20.00 | 8.00-10.50 | remaining |
| 304H | | | | | | | | portion |
| SUS | ≤0.030 | ≤1.00 | ≤2.00 | ≤0.045 | ≤0.030 | 18.0-20.00 | 9.00-13.00 | remaining |
| 304L | | | | | | | | portion |

The overall cross-sectional area of the wire conductor 10 is less than 0.13 mm². When the wire conductor 10 has such a small cross-sectional area, the diameter of the insulated wire 1 can be reduced, and the wire conductor 10 can be favorably used for connection to a small connector used in an automobile, for example. A small-diameter wire conductor having a cross-sectional area of less than 0.13 mm² can be more favorably used for communication than for electric conduction. From the viewpoint of facilitating a reduction in its diameter, the cross-sectional area of the conductor is more preferably not more than 0.10 mm². There is no particular limitation on the lower limit of the cross-sectional area of the conductor. However, from the viewpoint of keeping its strength from decreasing through an excessive reduction of its diameter, for example, its lower limit is preferably set to at least 0.02 mm², for example. It is possible to favorably adopt a conductor cross-sectional area of 0.05 mm².

The wire conductor 10 according to this embodiment includes the core wire 11 made of SUS, which has high material strength. Therefore, the wire conductor 10 overall has high tensile strength. Therefore, even when the wire conductor is used as a single wire or has a small diameter, the wire conductor has higher strength than a conventional and ordinary wire conductor made of a copper alloy. Also, when the wire conductor has a structure in which the copper coating layer 12, which has low rigidity, is disposed on the outer circumferential surface of the core wire 11 made of SUS, which has high rigidity, the wire conductor is less likely to buckle, compared to the conventional and ordinary wire conductor made of a copper alloy. Specific properties of the core wire 11 will be described later in detail. From the viewpoint of the wire conductor 10 exhibiting sufficient strength, the outer diameter of the core wire 11 is at least 0.11 mm, and more preferably at least 0.12 mm From the viewpoint of ensuring a sufficient thickness of the copper coating layer 12 while maintaining the small diameter of the wire conductor 10, for example, the outer diameter of the core wire 11 is preferably not more than 0.17 mm.

As described above, the wire conductor 10 has a structure in which the copper coating layer 12 is disposed on the outer circumferential surface of the highly rigid core wire 11 made of SUS, the copper coating layer 12 functions to keep the wire conductor 10 from buckling, and support the flow of electric current at the same time. The SUS forming the core wire 11 is not a highly conductive metal. However, the wire conductor 10 can ensure sufficient conductivity overall due to the presence of the copper coating layer 12 made of copper or a copper alloy, which is a highly conductive metal. The thickness of the copper coating layer 12 is determined such that the overall electric resistance of the wire conductor 10 is not more than 660 mΩ/m, for example. When the electric resistance of the wire conductor 10 is not more than 660 mΩ/m, the wire conductor 10 has sufficient conductivity for a communication cable. More preferably, the electric resistance of the wire conductor 10 is not more than 600 mΩ/m. There is no particular limitation on the electric resistance of the wire conductor 10. From the viewpoint of preventing the copper coating layer 12 from being excessively thick, for example, the electric resistance of the wire conductor 10 is preferably at least 500 mΩ/m, for example. The thickness of the copper coating layer 12 is preferable at least 40 μm and not more than 70 μm.

The insulating sheath 20 is formed using an organic polymer as a base material. There is no particular limitation on the type of organic polymer, and it is possible to use olefin-based polymers such as polyolefins and olefin-based copolymers, halogen-based polymers such as polyvinyl chloride, various elastomers, rubber, and the like. Various additives may be added to an organic polymer as appropriate. There is no particular limitation on the thickness of the insulating sheath 20. From the viewpoint of imparting sufficient insulation and the like, the thickness of the insulating sheath 20 is preferably at least 0.1 mm, for example. On the other hand, from the viewpoint of facilitating a reduction in the diameter of the insulated wire 1, the thickness of the insulating sheath 20 is preferably not more than 0.25 mm

<Properties of Wire Conductor>

Next, the properties of the wire conductor 10 will be described below in detail.

As described above, the wire conductor 10 according to this embodiment has a two-layer structure in which the copper coating layer 12 is provided on the outer circumferential surface of the core wire 11 made of SUS (may be referred to as “copper-clad SUS wire” hereinafter). The SUS forming the core wire 11 is a highly rigid metal having a high Young's modulus. On the other hand, copper or a copper alloy, in particular, pure copper, which forms the copper coating layer 12, is a low-rigidity metal having a Young's modulus lower than that of SUS. Because the SUS core wire 11 and the copper coating layer 12 are combined in the copper-clad SUS wire 10, the overall Young's modulus of the copper-clad SUS wire 10 is suppressed to less than 1.1×10⁵ MPa. As will be described in Examples later, the Young's modulus of a wire made of a Cu—Sn alloy, which is one of copper alloys that has relatively high strength and has been conventionally and ordinarily used as a constituent material of wire conductors, is about 1.1×10⁵ MPa, whereas the Young's modulus of the copper-clad SUS wire 10 according to this embodiment is lower than that of the Cu—Sn alloy wire. When the copper coating layer is softened through heat treatment, the Young's modulus of the copper-clad SUS wire 10 may also be less than 1.0×10⁵ MPa, less than 9.0×10⁴ MPa, or less than 8.0×10⁴ MPa. Although there is no particular limitation on the lower limit of the Young's modulus of the copper-clad SUS wire 10, the Young's modulus of the copper-clad SUS wire 10 is preferably at least 4.0×10⁴ MPa from the viewpoint of effectively suppressing buckling. The Young's modulus of a metal wire is evaluated through tensile testing conforming to JIS Z 2241.

Because the copper-clad SUS wire 10 according to this embodiment has a Young's modulus lower than that of the Cu—Sn alloy wire, the copper-clad SUS wire 10 has a smaller buckling force than the Cu—Sn alloy wire. The term “buckling force” refers to the magnitude of the force required to cause a wire to buckle, and a stronger buckling force indicates that a stronger force needs to be applied to cause the wire to buckle. In particular, as indicated by Euler's equation below, the higher the Young's modulus of a material forming the outer circumferential portion of a wire, the stronger the buckling force of the wire. This is because the material of the outer circumferential portion of the wire having a large area moment of inertia I contributes to the buckling force P.

P=(π²×ΣxI)/(4×L²) (1)

where P is buckling force (N), E is Young's modulus (MPa), I is the cross-sectionals 2D moment of inertia (mm⁴), and L is sample length (mm).

Therefore, the buckling force P is smaller when the copper coating layer 12 having a lower Young's modulus E is present, than when a Cu—Sn alloy having a higher Young's modulus E is present in the outer circumferential portion of the wire conductor. That is, the buckling force of the copper-clad SUS wire 10 according to this embodiment is smaller than that of a conventional and ordinary Cu—Sn alloy wire. This indicates that the copper-clad SUS wire 10 is more likely to buckle even when it is inserted into a connector terminal with a smaller force. In fact, it has been confirmed in the later examples that the copper-clad SUS wire 10 exhibits a smaller buckling force than a Cu—Sn alloy wire. From the viewpoint of the magnitude of buckling force, the copper-clad SUS wire 10 is more likely to buckle, compared to the Cu—Sn alloy wire.

However, even when the copper-clad SUS wire 10 according to this embodiment is deformed by buckling, the buckled wire readily returns to the unbuckled state due to the structural effect of the low-rigidity, i.e., highly flexible copper coating layer 12 provided on the outer circumferential surface of the highly rigid SUS core wire 11. This is because the SUS core wire 11, which has a high Young's modulus, exhibits a large restoring force, and the copper coating layer 12, which has a low Young's modulus, can flexibly return to the unbuckled state under the restoring force. In other words, even when a buckling force is applied to the copper-clad SUS wire 10, the force, which restores the copper-clad SUS wire 10 to a non-buckled state or a slightly buckled state, tends to be applied thereto. Therefore, if a buckling force is applied to the copper-clad SUS wire 10, then the copper-clad SUS wire 10 is unlikely to undergo irreversible buckling deformation under the applied force. In particular, as will be described later, if the copper-clad SUS wire 10 is heat-treated and the copper coating layer 12 is softened, the copper-clad SUS wire 10 is effective in suppressing its irreversible buckling deformation.

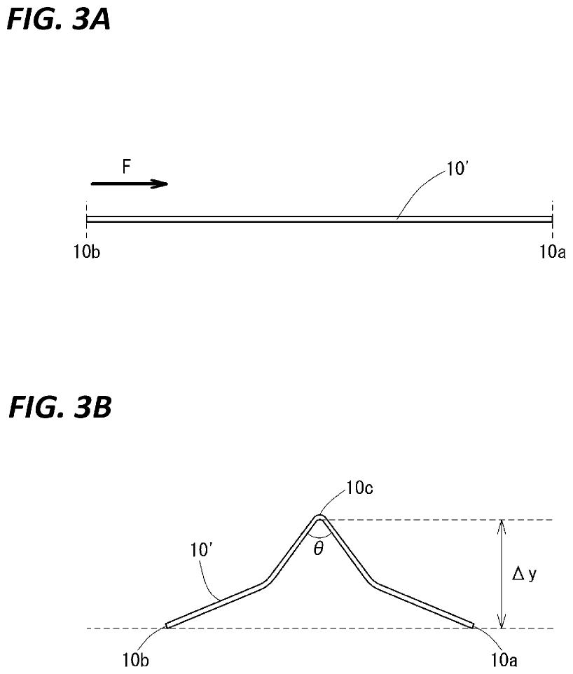

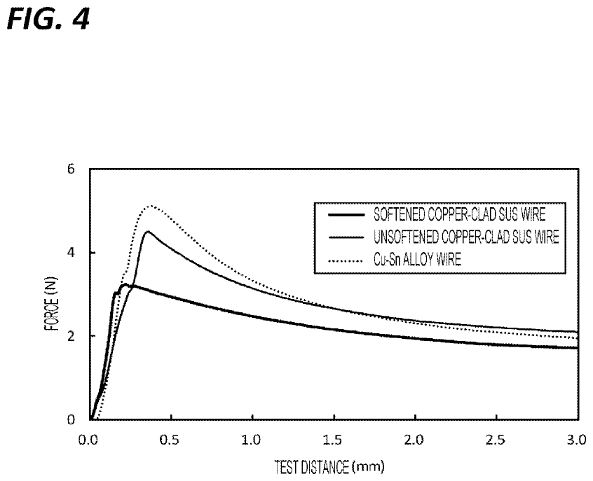

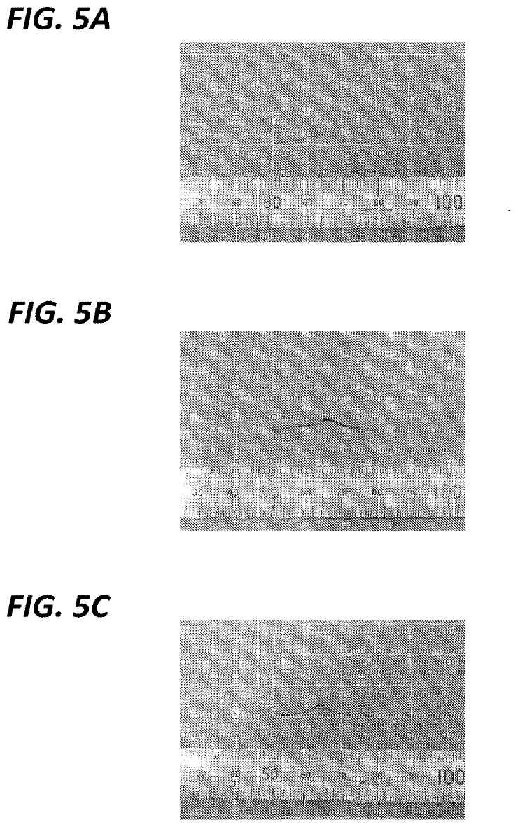

As shown in FIG. 3A, one end of a wire 10′ is fixed to form a fixed end 10a, and the other end of the wire 10′ is a moving end 10b. A force F is applied in a direction in which the moving end 10b is brought closer to the fixed end 10a and the wire 10′ is buckled as shown in FIG. 4B. The amount of deformation of the wire 10′ in the vertical direction due to buckling, i.e., the amount of buckling (buckling amount) Δy, is kept smaller when the wire 10′ is the copper-clad SUS wire 10 than when it is a Cu—Sn alloy wire. Here, the buckling amount Δy is defined as the distance between a straight line connecting the two ends 10a and 10b of the wire 10′ and a vertex portion of a buckled portion 10c. When the wire 10′ is the copper-clad SUS wire 10, the angle θ of the buckled portion 10c is also kept larger than when the wire 10′ is a Cu—Sn alloy wire, and the buckled portion 10c is less likely to bend sharply. Also, even when the wire 10′ is deformed such that the buckling amount Δy is temporarily increased while the force F is being applied, such as when the wire 10′ is inserted into a connector terminal, for example, the deformed wire 10′ is reversibly restored to the undeformed state when the application of the force F is stopped. That is, from the viewpoint of the magnitude of the buckling amount Δy when a wire is buckled, the copper-clad SUS wire 10 is less likely to buckle, compared to the Cu—Sn alloy wire. As will be confirmed in the later examples, the Cu—Sn alloy wire has a larger buckling amount Δy, and the buckled portion 10c tends to form a sharply bent shape (see FIG. 5C), whereas the buckling amount Δy of the copper-clad SUS wire 10 can be kept small, and the buckled portion 10c tends to have a slightly curved shape, instead of having a sharply bent shape (see FIG. 5A).

In this manner, the copper-clad SUS wire 10 is more likely to buckle than a Cu—Sn alloy wire, because the copper-clad SUS wire 10 has a smaller buckling force. However, the copper-clad SUS wire 10 is less affected by buckling than the Cu—Sn alloy wire in that the amount of buckling when the wire buckles is reduced. That is, the copper-clad SUS wire 10 is likely to buckle under a small force during insertion into a connector terminal. However, the amount of buckling when the wire buckles can be reduced. Also, deformation caused by buckling does not tend to irreversibly retained be.

Even if a wire conductor such as a Cu—Sn alloy wire having a stronger buckling force does not buckle unless a strong force is applied, once the wire conductor is buckled, so the amount of buckling increases, and the buckled state is irreversibly maintained, buckling has greater influence. Because of the influence of buckling, the wire conductor cannot be inserted into an end of a connector terminal or the wire conductor inserted into the connector terminal may be kept buckled, for example. On the other hand, even when the wire conductor 10, such as the copper-clad SUS wire according to this embodiment, buckles without applying a strong force when the wire conductor 10 is inserted into a connector terminal, the buckled wire conductor 10 can be completely inserted into the connector terminal in a nearly normal state as long as the amount of buckling of the wire conductor 10 is small. Also, even if the wire conductor 10 buckles due to a deviation in the angle, position, or the like during insertion of the wire conductor 10 into a connector terminal, at least a portion of the buckled wire conductor reversibly returns to the unbuckled state if the application of force is stopped by temporarily removing the wire conductor 10 from the connector terminal. Therefore, after the angle or position is changed and the wire conductor 10 is re-inserted into the connector terminal, the wire conductor 10 can be normally inserted into the connector terminal. The wire conductor 10 constituted by the copper-clad SUS wire according to this embodiment has a structure in which a low-rigidity copper coating layer 12 is disposed on the outer circumferential surface of the highly rigid core wire 11. As a result of the effect of this structure, the amount of buckling is reduced to a small amount, and the buckled wire conductor 10 readily returns to the unbuckled state, thus reducing the influence of buckling.

In this embodiment, the SUS core wire 11 and the copper coating layer 12 may also have any physical properties as long as the copper-clad SUS wire 10 overall has the predetermined Young's modulus. When SUS has a Young's modulus higher than that of copper and a copper alloy, the SUS core wire 11 alone exhibits a Young's modulus higher than that of the copper-clad SUS wire 10. However, the Young's modulus of the SUS core wire 11 is preferably more than 1.1×10⁵ MPa, which is the Young's modulus of the Cu—Sn alloy wire. Furthermore, the Young's modulus of the SUS core wire 11 is at least 1.2×10⁵ MPa, or preferably at least 1.5×10⁵ MPa. The SUS core wire 11 having a higher Young's modulus increases the overall buckling force of the copper-clad SUS wire 10, and exhibits a high restoring force. Therefore, the SUS core wire 11 is most effective in reducing the buckling amount, and is capable of reducing the influence of buckling in terms of both improving the buckling force and reducing the buckling amount.

The copper-clad SUS wire 10 has the core wire 11 made of SUS and thus has a tensile strength higher than that of a conventional and ordinary Cu—Sn alloy wire. Although the tensile strength of the copper-clad SUS wire 10 can be adjusted depending on heat treatment conditions, the tensile strength does not significantly affect the buckling amount as will be described in the later examples. However, when the copper-clad SUS wire 10 has a high tensile strength and the copper-clad SUS wire 10 inserted into the connector terminal is crimped and connected thereto, the crimped portion can have high crimp strength. That is, the copper-clad SUS wire 10 compressed at the crimped portion is unlikely to break. The copper-clad SUS wire 10 is inserted into the connector terminal while the influence of buckling is reduced utilizing a small buckling amount of the copper-clad SUS wire 10. Then, the crimped portion having high connection strength can be formed through crimp connection, utilizing high tensile strength of the copper-clad SUS wire 10. From the viewpoint of effectively increasing the crimp strength of the crimped portion, the tensile strength of the copper-clad SUS wire 10 is preferably at least 950 MPa, and more preferably at least 970 MPa. The tensile strength of a metal wire can be evaluated as tensile strength at break through tensile testing conforming to JIS Z 2241.

The upper limit of the tensile strength of the copper-clad SUS wire 10 is not particularly specified. However, even if its tensile strength is excessively high, the connection strength at a portion connected to the connector terminal may decrease. This is because if the copper-clad SUS wire 10 has high strength and is excessively hard, the strength of a material of the connector terminal may decrease when the copper-clad SUS wire 10 is crimped and connected to the connector terminal, and the copper-clad SUS wire 10 cannot be sufficiently deformed, for example, and thus the copper-clad SUS wire 10 cannot be firmly held by the connector terminal, resulting in a decrease in the connection strength. From the viewpoint of avoiding such situations and ensuring high connection strength, the tensile strength of the copper-clad SUS wire 10 is preferably not more than 1200 MPa, and more preferably not more than 1080 MPa. The copper-clad SUS wire 10 having a tensile strength in a range of 950 MPa to 1200 MPa can be favorably manufactured through the heat treatment described later.

As described above, the crimp strength of the crimped portion is greatly affected by the tensile strength of the copper-clad SUS wire 10 when connecting the copper-clad SUS wire 10 to a crimp terminal. However, the breaking elongation of the copper-clad SUS wire 10 also affects the crimp strength. High crimp strength can be easily obtained when the overall breaking elongation of the copper-clad SUS wire 10 is at least 1.5%, at least 1.8%, at least 2.0%, or at least 2.2%, for example. Further, when the copper-clad SUS wire 10 has such breaking elongation, high crimp strength can be stably obtained even when the tensile strength of the copper-clad SUS wire 10 fluctuates due to variations in the heat treatment conditions and the like. SUS 304H can be favorably used as a SUS material for realizing high tensile strength and breaking elongation through heat treatment. The breaking elongation of a metal wire can be evaluated as tensile testing conforming to JIS Z 2241.

<Method for Manufacturing Wire Conductor>

With a method for manufacturing the wire conductor 10 according to this embodiment constituted as a copper-clad SUS wire, the SUS core wire 11 having a predetermined diameter is manufactured through wire drawing, and then the copper coating layer 12 need only be formed on the surface of the core wire 11 through plating or vapor deposition, for example. Alternatively, the copper-clad SUS wire 10 can also be manufactured by fitting a ring-shaped copper member, which will serve as the copper coating layer 12, around the SUS member, which will serve as the core wire 11, and drawing them together into a single member with a predetermined diameter.

The insulated wire 1 may be formed directly using the copper-clad SUS wire 10 obtained as described above, and used for connection to the connector terminal. However, the obtained copper-clad SUS wire 10 is preferably heat treated (annealed). The copper coating layer 12 is softened through heat treatment. As a result, the flexibility of the copper coating layer 12 is improved, and the buckling amount is more effectively reduced by providing a highly flexible copper coating layer 12 on the outer circumferential surface of the highly rigid SUS core wire 11 in the copper-clad SUS wire 10. The heat treatment temperature ranges from 100° C. to 400° C., for example. The heat treatment may be performed at a temperature ranging from 250° C. to 400° C., for example. The heat treatment may be performed through continuous softening for resistive heating the copper-clad SUS wire 10, or batch softening for heating the copper-clad SUS wire 10 in a batch furnace at a predetermined temperature.

The overall Young's modulus of the copper-clad SUS wire 10 typically decreases from a high Young's modulus of at least 9.0×10⁴ MPa to less than 9.0×10⁴ MPa, through heat treatment. Changes in the state of the copper coating layer 12 through heat treatment can also be confirmed using the hardness of the copper coating layer 12 as an index. The hardness of the copper coating layer 12 at a cross-section of the copper-clad SUS wire 10 is typically at least 130 Hv, or at least 150 Hv before heat treatment, and not more than 120 Hv, or not more than 100 Hv after softening is performed through heat treatment.

<Insulated Wire with Another Form—Flat Wire>

The wire conductor 10 configured as the copper-clad SUS wire according to the above embodiment may also be used in any form, and is not limited to a simple insulated wire 1 in which the entire circumferential surface of one wire conductor 10 as shown in FIG. 1 is covered by the insulating sheath 20. A flat wire will be briefly described as an example in which an insulated wire according to another embodiment is formed using wire conductors 10 according to the embodiment.

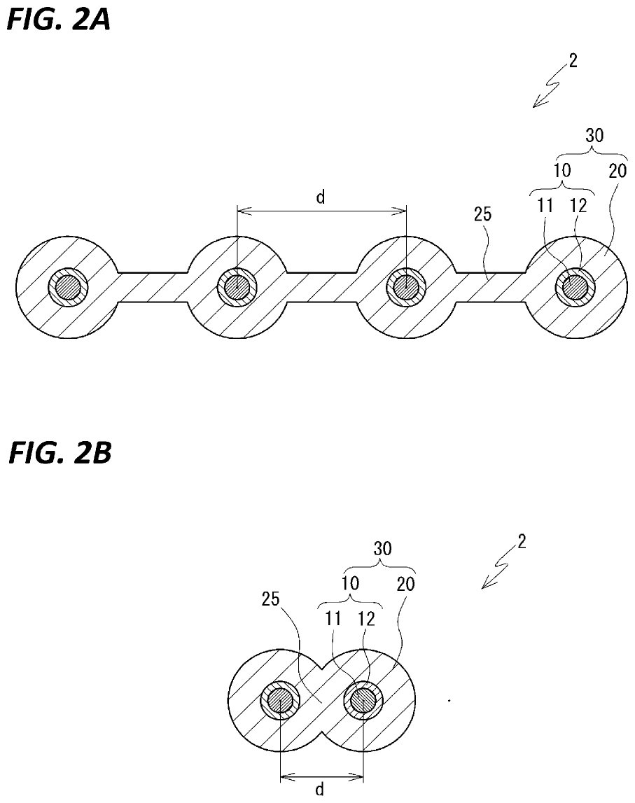

Cross-sections of flat wires 2 are shown in FIGS. 2A and 2B. FIGS. 2A and 2B show flat wires having different forms. The flat wire 2 includes a plurality of the wire conductors 10 according to an embodiment of this disclosure described above. The number of wire conductors 10 is not particularly specified, and it is possible to favorably adopt a number ranging from 2 to 8. In particular, the number of wire conductors 10 may be an even number such that pairs of wires can be formed.

In the flat wire 2, a plurality of wire conductors 10 are arranged parallel to each other in one direction, with their axial directions arranged parallel to each other. The outer circumferential surfaces of the wire conductors 10 arranged side-by-side are respectively covered by insulating sheaths 20, and thus a plurality of covering portions 30 each of which is constituted by the wire conductor 10 and the insulating sheath 20 are formed. Also, the covering portions 30 are connected to each other by connection portions 25. The insulating sheaths 20 forming the covering portions 30 and the connection portions 25 are formed as a single body using the same material. In the embodiment shown in FIG. 2A, connection portions 25 are formed by connecting covering portions 30 having a substantially circular cross-section. On the other hand, in the embodiment shown in FIG. 2B, adjacent covering portions 30 are directly joined together such that their substantially circular cross-sectional shapes overlap each other, and portions of the insulating sheaths 20 forming the covering portions 30 function as a connection portion 25. From the viewpoint of ensuring the flexibility of the flat wire 2 in any form and facilitating tearing of the flat wire 2 during terminal processing, for example, the thickness of the connection portion 25 (its length in a direction orthogonal to the direction in which the wire conductors 10 are arranged parallel to each other) is preferably smaller than the diameter of the covering portion 30.

There is no particular limitation on the distance between wire conductors 10 arranged parallel to each other. A distance d between adjacent wire conductors 10 (the distance between the centers of the wire conductors 10) may be at least 0.2 mm, at least 0.4 mm, or at least 0.8 mm. As a result, sufficient insulation between wire conductors 10 can be ensured. In particular, in the embodiment shown in FIG. 2A, the distance d between adjacent wire conductors 10 is preferably at least 0.4 mm. On the other hand, the distance d between at least two adjacent wire conductors 10 is preferably not more than 1.2 mm, or not more than 1.0 mm. As a result, these two wire conductors 10 can be favorably used as a pair of wires for transmitting differential signals while ensuring the required characteristic impedance. Note that if the flat wire 2 includes three or more wire conductors 10, the distance d between the wire conductors 10 may be longer than 1.2 mm, or all the wire conductors 10 may be arranged at equal intervals of not more than 1.2 mm at portions other than the two wire conductors 10 forming the pair of wires.

Use of the flat wire 2 makes it possible to collectively connect a plurality of wire conductors 10 to a connector having a plurality of terminals arranged side-by-side. As described above, because the buckling amount is reduced, the wire conductor 10 according to this embodiment of this disclosure is capable of reducing the influence of buckling when being inserted into a connector terminal. Thus, a plurality of wire conductors 10 can be collectively and easily inserted into a plurality of connector terminals simultaneously. The wire conductor 10 according to an embodiment of this disclosure has high strength. The overall strength of the flat wire 2 can be further increased by arranging a plurality of wire conductors 10 parallel to each other. Also, when a twisted pair wire is formed by twisting together independent insulated wires 1 shown in FIG. 1, it tends not to stably maintain its twisted structure because the wire conductor 10 has high rigidity due to the high strength of the wire conductor 10. However, when the flat wire 2 is formed by arranging a plurality of wire conductors 10 side-by-side and the distance d between wire conductors 10 is kept constant using connection portions 25, differential signals can be stably transmitted.

### Examples

Examples will be described below. Note that the present invention is not limited to these examples. Hereinafter, samples are produced and evaluated at room temperature in the atmosphere, unless otherwise stated.

(1) Material and Buckling Force of Wire Conductor

First, the relationship between the material and the buckling force of a wire conductor was examined

<Preparation of Samples>

Three types of wire conductors were prepared as samples. First, a copper-clad SUS wire was produced which includes a core wire made of SUS 304H and a copper coating layer made of pure copper. The outer diameter of the core wire was 00.16 mm, and the thickness of the copper coating layer was 45 μm. The overall outer diameter of the copper-clad SUS wire was 00.25 mm and the cross-sectional area of its conductor was 0.05 mm². The obtained copper-clad SUS wire was directly used as an “unsoftened” sample. On the other hand, continuous softening was performed on the obtained copper-clad SUS wire to prepare a “softened” sample. A 00.25-mm Cu—Sn alloy wire (Sn content: 0.3 mass %) was separately prepared.

Physical properties of the wire conductors prepared above are listed in Table 2 below. Table 2 also shows the physical properties of a SUS core wire alone (00.16 mm, unsoftened), which was used as the raw material of the copper-clad SUS wire.

TABLE 2

| | Softened | | Unsoftened | | | | | |
|---|---|---|---|---|---|---|---|---|
| | copper-clad | | copper-clad | | SUS core | | Cu—Sn alloy | |
| | SUS wire | | SUS wire | | wire | | wire | |
| Tensile strength | 1061 | MPa | 1233 | MPa | 2511 | MPa | 735 | MPa |
| Breaking elongation | 2.1% | | 2.2% | | 2.4% | | 2.4% | |
| Young's modulus | 7.8 × 10⁴ | MPa | 1.0 × 10⁵ | MPa | 1.6 × 10⁵ | MPa | 1.1 × 10⁵ | MPa |

Insulated wires were produced by respectively forming insulating sheaths on the outer circumferential surfaces of the softened copper-clad SUS wire, unsoftened copper-clad SUS wire, and Cu—Sn alloy wire prepared above. The insulating sheath with a thickness of 0.20 mm was formed by extrusion molding PVC.

<Evaluation Method>

The buckling force of the insulated wires respectively having the wire conductors produced above was measured. Each insulated wire was cut to 30 mm, and a buckling test was performed. As shown in FIG. 3A, in the buckling test, one end of the insulated wire was fixed to form a fixed end 10a, and the other end of the insulated wire was a moving end 10b. A force F was applied to the moving end 10b toward the fixed end 10a. At that time, the distance by which the moving end 10b moved was used as a test distance, and the relationship between the test distance and the applied force F was recorded. The maximum applied force F was a buckling force. The moving speed of the moving end 10b was 25 mm/min. In the tester used, a jig for holding two ends of a sample insulated wire was provided with holes with a depth of 10 mm for fixing the sample.

<Results of Evaluation>

FIG. 4 shows the relationship between the test distance and the force applied to the insulated wire obtained in the buckling test. The buckling force of each wire read as the maximum force applied is listed in Table 3 below.

TABLE 3

| Wire conductor | Buckling force |
|---|---|
| Softened copper-clad SUS wire | 3.24N |
| Unsoftened copper-clad SUS wire | 4.50N |
| Cu—Sn alloy wire | 5.10N |

According to FIG. 4 and Table 3, the softened copper-clad SUS wire and the unsoftened copper-clad SUS wire had a smaller buckling force than the Cu—Sn alloy wire. That is, the copper-clad SUS wire buckles under a smaller force, compared to the Cu—Sn alloy wire. In particular, the softened copper-clad SUS wire exhibited a smaller buckling force.

According to Euler's equation represented by formula (1) above, a material having a higher Young's modulus has a larger buckling force. According to Table 2, the Cu—Sn alloy wire had a higher Young's modulus than the copper-clad SUS wire, and the results of measurement of the buckling force agree with the relationship indicated by Euler's equation. Further, according to Euler's equation, the material located in an outer circumferential portion of a wire conductor greatly contributes to a buckling force due to the effect of the area moment of inertia. The copper-clad SUS wire has, on its surface, the copper coating layer made of a material having a low Young's modulus, and correspondingly, the copper-clad SUS wire has, as the difference in the buckling force, a difference larger than the difference in the overall Young's modulus, in comparison with the Cu—Sn alloy wire. Also, it seems that the Young's modulus of the copper-clad SUS wire, in particular, the Young's modulus of its outer circumferential portion, is further reduced through heat treatment, and thus the buckling force of the softened copper-clad SUS wire is even smaller than that of the unsoftened copper-clad SUS wire.

It was confirmed that, when the contribution of the insulating sheath to the buckling force was separated from the contribution of the wire conductor through theoretical calculation based on Euler's equation, the softened copper-clad SUS wire serving as the wire conductor contributed to at least half of the buckling force of the entire insulated wire measured in the test. That is, the difference in the buckling force between insulated wires obtained in the test is caused by the difference in the buckling force between wire conductors.

(2) Material and Buckling Amount of Wire Conductor

Next, the relationship between the material and the buckling amount of a wire conductor was examined

<Production of Samples>

The same insulated wires used in the test (1) and respectively having three types of conductors (softened copper-clad SUS wire, unsoftened copper-clad SUS wire, and Cu—Sn alloy wire) were used as samples.

A buckling test was performed in the same manner as in the test (1). The buckling test was stopped when a predetermined test distance set at intervals of 0.5 mm between 0.5 mm and 2.5 mm. Then, the insulated wire was removed from the tester, and the buckling amount Δy, i.e., the amount of change in its vertical length was measured. For each test distance, a measurement was performed three times using different samples, and the average of the buckling amounts was recorded.

<Results of Evaluation>

FIGS. 5A to 5C show states of the insulated wires respectively having the softened copper-clad SUS wire, unsoftened copper-clad SUS wire, and Cu—Sn alloy wire when each sample was buckled at a test distance of 2.0 mm A buckled portion at the center of the Cu—Sn alloy wire shown in FIG. 5C was sharply bent, and the buckled portion had a small angle θ. The Cu—Sn alloy wire also had a large buckling amount. On the other hand, the insulated wire having the softened copper-clad SUS wire shown in FIG. 5A had a slightly curved shape, and the buckled portion had a large angle θ. The buckling amount was clearly smaller than that in FIG. 5C. The unsoftened copper-clad SUS wire shown in FIG. 5B had an intermediate state between the states shown in FIGS. 5A and 5C.

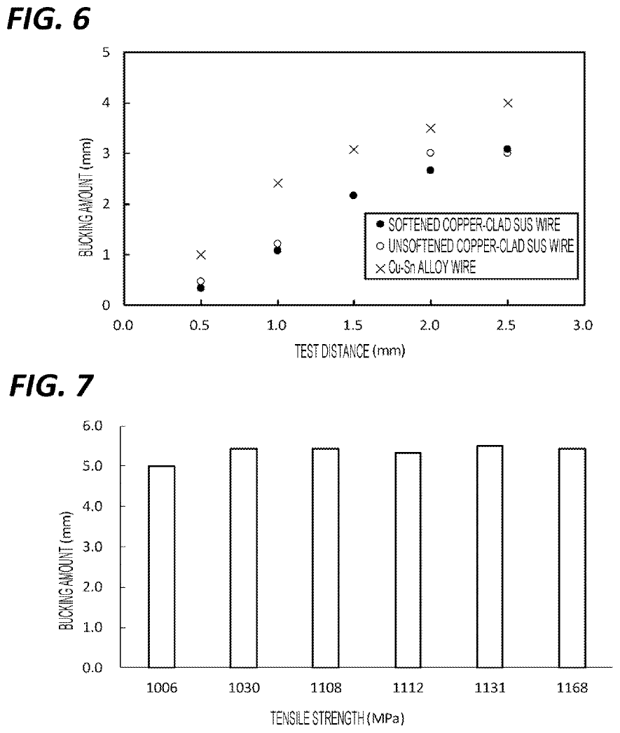

The results obtained by measuring the buckling amount shown in FIG. 6C clearly had the trend observed in the comparison between states shown in FIGS. 5A to 5C. Two types of copper-clad SUS wires had a smaller buckling amount than the Cu—Sn alloy wire at all of the test distances. Based on these results, it can be seen that, because a low-rigidity copper coating layer was disposed on the outer circumferential surface of a highly rigid SUS core wire in the copper-clad SUS wire, the copper-clad SUS wire deformed through buckling readily returns to the unbuckled state.

Further, a comparison between the results of the unsoftened copper-clad SUS wire and the softened copper-clad SUS wire reveals that the softened copper-clad SUS wire had a slightly smaller buckling amount in a region up to a test distance of 2.0 mm Based on these results, it can be seen that the flexibility of the copper coating layer was improved through heat treatment, and the softened copper-clad SUS wire deformed through buckling is more effective in returning to the unbuckled state. The hardness of the copper coating layer measured at a cross-section of the unsoftened copper-clad SUS wire was 152 Hv, and the hardness of the copper coating layer measured at a cross-section of the softened copper-clad SUS wire was 93 Hv.

(3) Tensile Strength and Buckling Amount of Copper-Clad SUS Wire

Next, the relationship between the tensile strength and the buckling amount of a copper-clad SUS wire was examined

<Production of Samples>

Prepared were the same samples as the insulated wires having the heat-treated copper-clad SUS wires produced in the above test (1). However, a plurality of copper-clad SUS wires with different tensile strengths were produced by changing the heat treatment conditions for softening. Note that the electric resistance of each wire conductor was not more than 600 mΩ/m even when the wire was heat-treated under any of the conditions.

The tensile strength at break of the copper-clad SUS wires produced above was evaluated through tensile testing conforming to JIS Z 2241. Also, a buckling test was performed on the insulated wires having the copper-clad SUS wires in the same manner as in the above test (2), and the buckling amount Δy was measured at a test distance of 5.0 mm. The length of the insulated wires used in the test was 30 mm A measurement was also performed three times using different samples, and the average of the buckling amounts was recorded.

<Results of Evaluation>

FIG. 7 shows the relationship between the tensile strength and the buckling amount of copper-clad SUS wires, using a bar graph. As shown in FIG. 7, the buckling amount does not correlate with the tensile strength, resulting in similar buckling amounts at any tensile strength. This result indicates that the tensile strength of the copper-clad SUS wire does not significantly affect the buckling amount.

It seems that the wire conductor is buckled and the buckled wire conductor returns to the unbuckled state due to the movement of an elastic region of the wire conductor, almost independent of a plastic region and the tensile strength corresponding to its movement at break. In Euler's equation represented by the formula (1), the buckling strength depends on Young's modulus, which is a physical property of the elastic region. This is consistent with the evaluation results shown in FIG. 7. In general, the tensile strength of SUS wire may greatly vary depending on heat treatment conditions, whereas the Young's modulus is not significantly affected by the heat treatment conditions.

(4) Tensile Strength and Crimp Strength of Copper-Clad SUS Wire

Next, the relationship between the tensile strength of a copper-clad SUS wire and crimp strength at its portion connected to a terminal was examined

<Production of Samples>

A plurality of copper-clad SUS wires with different tensile strengths were produced by changing the heat treatment conditions for softening in the same manner as in the above test (3). A copper alloy conductor (tensile strength: 740 MPa, breaking elongation: 2.1%) having a cross-sectional area of 0.05 mm² was also prepared as a reference sample.

<Evaluation Method>

The tensile strength at break of the produced wire conductors was evaluated through tensile testing conforming to JIS Z 2241. Further, the produced wire conductors were cut to a length of 104 mm, and crimped and connected to a crimp terminal to prepare conductors provided with the terminal. Crimp terminals made of a copper alloy were used, and when being crimped and connected to the crimp terminals, the wire conductors were held and compressed from opposite directions in a region of the wire conductor having a length of 1.6 to 3.0 mm along its axial direction. Two types of crimped portions, namely, a low-compression portion and a high-compression portion, were formed by changing the degree of compressing the conductor. Low compression is applied to a portion where an ordinary connector terminal and a wire conductor are connected to each other, and a high compression state refers to a state in which a wire conductor is compressed under more severe conditions than ordinary conditions.

A crimp terminal was fixed to the obtained conductor provided with the terminal, and an end portion of the wire conductor was pulled. Then, the maximum force applied until the wire conductor broke at its crimped portion was recorded as crimp strength. The pulling speed was 100 mm/min. Note that the crimped portions of all the samples broke because the wire conductors broke inside the crimp terminals, but the wire conductors did not detach from the crimp terminals.

<Results of Test>

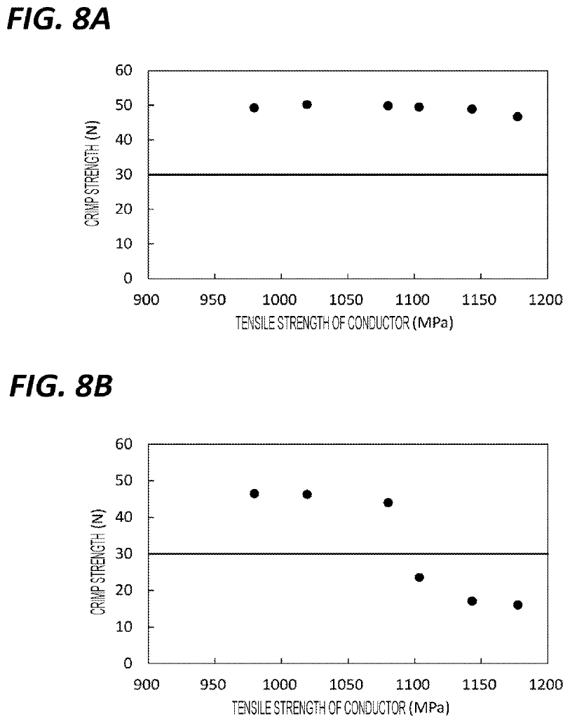

FIGS. 8A and 8B show the relationship between the tensile strength and crimp strength of copper-clad SUS wires. FIG. 8A shows the results for low compression portions, and FIG. 8B shows the results for high compression portions. The solid lines indicate a crimp strength of 30 N in FIGS. 8A and 8B.

The low-compression portions in FIG. 8A had a crimp strength of at least 30 N in the entire tensile strength range of at least 950 MPa. On the other hand, the high-compression portions had a crimp strength of at least 30 N at the tensile strength of a wire conductor ranging from 950 MPa to 1080 MPa. The crimp strength decreased when the tensile strength was higher than 1080 MPa. This is because the material strength of the crimp terminal was reduced due to the hardness of the wire conductor, and the wire conductor was not firmly held by the crimp terminal. Note that the crimp strength of the copper alloy conductor of the reference sample was 23.6 N under low compression, and 25.4 N under high compression.

As confirmed in the above test (3), the tensile strength of the copper-clad SUS wire does not affect the buckling amount, but affects the crimp strength of the portion connected to the terminal, based on the results shown in FIGS. 8A and 8B. That is, in order to ensure high crimp strength after the copper-clad SUS wire is inserted into the portion connected to the connector terminal while reducing the influence of buckling and is crimped and connected, tensile strength needs to be set as appropriate. As described above, low compression is applied to the portion where the ordinary connector terminal and the wire conductor are connected to each other. In order that the portion connected to such an ordinary connector terminal has a high crimp strength of at least 30 N, heat treatment conditions under which the copper-clad SUS wire is heat-treated need to be selected to have a tensile strength of at least 950 MPa. Further, if a wire needs to be connected to a connector terminal under more severe conditions than ordinary conditions, it is preferable that tensile strength is not excessively increased. Note that the breaking elongation of the tested copper-clad SUS wire ranged from 1.9% to 2.2%.

The present invention is not merely limited to the above embodiments, and various modifications can be made without departing from the gist of the present invention.

Note that the configuration of the flat wire 2 described above can be applied to other wire conductors than the wire conductors according to the embodiments of this disclosure. If a copper alloy wire such as a Cu—Sn alloy wire is used, for example, the effect of improving strength and reducing the diameter of the wire conductors can be obtained by arranging small-diameter wire conductors having a cross-sectional area of less than 0.32 mm² parallel to each other. That is, in order to ensure the wire strength when the diameters of a plurality of wire conductors in an insulated wire are reduced, the insulated wire may be configured as follows.

The insulated wire includes:
a plurality of single wire conductors having a cross-sectional area of less than 0.32 mm² and arranged parallel to each other,
a covering portion is formed by covering an outer circumferential surface of each of the wire conductors by an insulating sheath, and
the covering portions are connected to each other by one or more connection portions that are formed as single bodies with the insulating sheaths of the covering portions.

The distance between at least two adjacent wire conductors in the insulated wire preferably ranges from 0.2 mm to 1.2 mm. In particular, the distance is preferably not more than 1.0 mm. In addition, the above-described embodiments can be favorably applied to a configuration relating to a flat wire.

### LIST OF REFERENCE NUMERALS

1 Insulated wire
2 Flat wire
10 Wire conductor (copper-clad SUS wire)
10′ wire
10a Fixed end
10b Moving end
10c Buckled portion
11 Core wire
12 Copper coating layer
20 Insulating sheath
25 Connection portion
30 Covering portion
d Distance between wire conductors
F Force applied to wire
Δy Buckling amount
θ Angle of buckled portion

1. A wire conductor for use as a single wire, comprising:
a single core wire made of stainless steel; and
a copper coating layer made of copper or a copper alloy and covering an outer circumferential surface of the core wire,
wherein the wire conductor has a cross-sectional area of less than 0.13 mm², and
has a Young's modulus of less than 1.0×10⁵ MPa.

2. The wire conductor according to claim 1,
wherein the core wire has a Young's modulus of at least 1.2×105 MPa.

3. The wire conductor according to claim 1,
wherein the wire conductor has a tensile strength of at least 950 MPa.

4. The wire conductor according to claim 1,
wherein the stainless steel forming the core wire is SUS 304H.

5. The wire conductor according to claim 1,
wherein the wire conductor has a tensile strength of not more than 1080 MPa.

6. The wire conductor according to claim 1,
wherein the wire conductor is heat-treated at a temperature ranging from 100° C. to 400° C. in a state in which the copper coating layer is formed on a surface of the core wire.

7. An insulated wire comprising:
the wire conductor according to claim 1; and
an insulating sheath covering an outer circumferential surface of one of the wire conductors.

8. The insulated wire according to claim 7,
wherein a plurality of the wire conductors are arranged parallel to each other,
a covering portion is formed by covering an outer circumferential surface of each of the wire conductors by the insulating sheath, and
the covering portions are connected to each other by one or more connection portions that are formed as single bodies with the insulating sheaths of the covering portions.

9. The insulated wire according to claim 8,
wherein the distance between at least two adjacent wire conductors ranges from 0.2 mm to 1.2 mm.
